(19) United States
(12) Patent Application Publication
(10) Pub. No.: US 2015/0307048 A1
(43) Pub. Date: Oct. 29, 2015

(54) AUTOMOBILE ALERT INFORMATION SYSTEM, METHODS, AND APPARATUS

(71) Applicant: Creative Inovation Services, LLC, Pine Brook, NJ (US)

(72) Inventor: Thomas Santora, Holmdel, NJ (US)

(21) Appl. No.: 14/259,769

(22) Filed: Apr. 23, 2014

(51) Int. Cl. B60R 21/013; B60R 1/00; B60R 21/00; H04N 7/18

(52) U.S. Cl. CPC B60R 21/013; H04N 7/181; B60R 1/00; B60R 21/00; H04N 7/188; B60R 2021/0027

(57) ABSTRACT

A system, methods, and apparatus for providing automobile alert information are disclosed. An example embodiment includes, sensing accelerometer values to detect a collision, determining a location, capturing video with multiple cameras, storing first video data for a period of time, transmitting automobile identification data, determining whether an accelerometer value exceeds a threshold, in response to the value exceeding the threshold, storing automobile identification data of a second automobile, continuing to capture and store second video data, transmitting the accelerometer value, the location, and the automobile identification data of the second automobile, and transmitting the first and second video data, which were recorded prior to, during, and after the collision occurred, and an alert message is received at a user device in response to the accelerometer value exceeding the threshold, and the user device is configured to access the first and second video data.

### BACKGROUND

Automobile users often are required to put their automobile in an unsecure or unsafe environment. Typically, many automobile users leave their automobile unattended for periods of time ranging from hours to days, for example, in a parking lot at a shopping center, a sporting event, a train station, an airport, or the like. An automobile left unattended may be damaged by hit and run drivers, thieves, vandals, and various other threats to automobiles. When damage is inflicted upon an unattended automobile, users typically are not alerted to the situation until well after the damage occurs, and rarely in time to determine exactly what happened and hold any offending parties accountable for the damage. Users of automobiles that desire greater security may elect to park in secured parking lots with video surveillance security systems or the like. Moreover, while secured parking may often be suitable for providing a general description of a make and model of an offending automobile, this level of security often fails to result in the offender being held accountable. Oftentimes, secured parking does not capture specific identifying information that can be used to identify the offender, such as a license plate number. Given the relatively limited security that secured parking provides, many users forgo the luxury of secured parking, instead preferring to minimize the costs associated with automobile ownership and operation.

Furthermore, unsafe or unsecure environments may occur even while an automobile is attended by the user, for example, when the user is driving the automobile. Incidents occurring while a user is driving the automobile are often more serious in nature than incidents occurring while the automobile is left unattended. For example, hit and run driver incidents which result in injury to users of automobiles and great damage to the automobiles are all too common. In such situations, it is typical for automobile users, authorities, and insurers to experience significant difficulty in determining exactly what happened, and oftentimes, even fail to determine which parties should be held accountable and/or partially accountable for the damage and any injury which has occurred.

### SUMMARY

The present disclosure provides a new and innovative system, methods and apparatus for providing automobile alert information to users. In an example embodiment, a method includes sensing and storing accelerometer values over a first period of time to detect a collision, determining and storing a location with the GPS unit, capturing a first video image with each of the plurality of cameras, and storing first video data for each of the first video images captured by each of the plurality of cameras for a second period of time. The example embodiment further includes transmitting, from the inter-automobile communication unit, automobile identification data for the first automobile, and determining whether at least one accelerometer value exceeds a predetermined threshold which is indicative of a collision with a second automobile. Then, in response to the at least one accelerometer value exceeding the predetermined threshold storing automobile identification data of the second automobile received at the inter-automobile communication unit, continuing to capture a second video image with each of the plurality of cameras, storing second video data for each of the second video images captured by each of the plurality of cameras, transmitting, from the external communication unit, the at least one accelerometer value that exceeded the predetermined threshold, the location, and the automobile identification data of the second automobile, and transmitting, from the external communication unit, the first video data and the second video data, which were recorded during the second period of time prior to the collision, during a third period of time while the collision occurred, and during a fourth period of time after the collision occurred. An alert message is received at a user device in response to the at least one accelerometer value exceeding the predetermined threshold, and the user device is configured to access the first video data and the second video data.

Additional features and advantages of the disclosed method and apparatus are described in, and will be apparent from, the following Detailed Description and the Figures.

### BRIEF DESCRIPTION OF THE FIGURES

FIG. 1 is a high level block diagram of an automobile alert system, according to an example embodiment of the present disclosure.

FIG. 2 is a block diagram showing an example of a computing device, according to an example embodiment of the present disclosure.

FIG. 3 is a block diagram showing an example of an automobile alert apparatus, according to an example embodiment of the present disclosure.

FIG. 4 is a diagram showing an example of an automobile, according to an example embodiment of the present disclosure.

FIG. 5 is a flow diagram illustrating an example process for providing automobile alert information using an example of a server system, according to an example embodiment of the present disclosure.

FIGS. 6a and 6b provide a flowchart illustrating an example process for providing automobile alert information, according to an example embodiment of the present disclosure.

### DETAILED DESCRIPTION OF EXAMPLE EMBODIMENTS

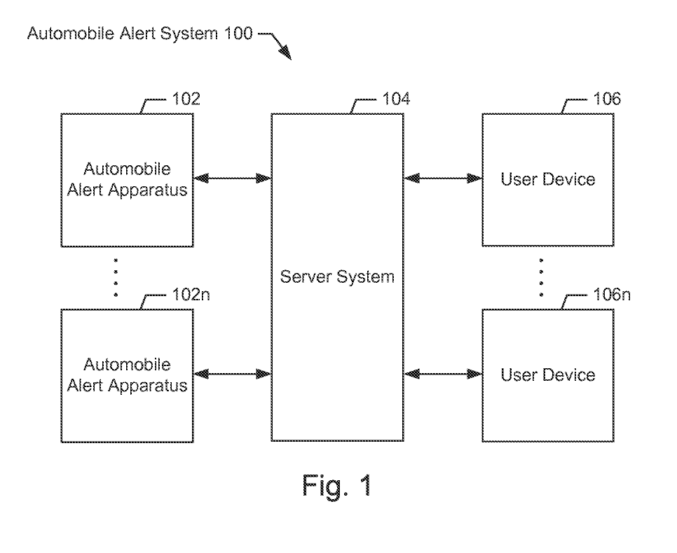

A high level block diagram of an example automobile alert system 100 is illustrated in FIG. 1. The illustrated automobile alert system 100 includes a plurality of automobile alert apparatuses 102 to 102n, a server system 104, and a plurality of user devices 106 to 106n. In an example embodiment, an automobile alert apparatus 102 includes a plurality of components mounted within an automobile, which are configured to detect collisions and provide automobile alert information about collisions. Automobile alert information may include various information regarding a collision such as recorded video of the collision, an impact level, a location of the automobile, a date and time, and information identifying another automobile involved in the collision. In an example embodiment, the server system 104 receives alert information from the automobile alert apparatus 102 and stores the alert information for at least a period of time. The server system 104 also provides at least a portion of the alert information to at least one user device 106. The user device 106 provides alert information to a user when a collision occurs. For example, a user may receive a notification (e.g., a text message) on their user device 106 (e.g., smartphone), which indicates that a collision has occurred and includes various information regarding the collision. The user may view a video of the collision on the user device 106 and take any measures necessary to handle the situation, such as contact the police, an insurance company, a taxi, etc.

Utilizing the presently disclosed automobile alert system 100, when a collision involving a user's automobile occurs, the user may advantageously be provided with an alert in real-time, whether the collision is a major wreck, a fender bender, or a minor ding, and view video of the entire incident from start to finish. Accordingly, the user can take appropriate action based on the information provided with the alert and/or the video. For example, if the video shows that a minor ding from a nearby car or a runaway shopping cart occurs, and a person writes a note and leaves it on the user's automobile, the user may decide to continue working and deal with the situation later, as it appears to be minor and not urgent. On the other hand, if the video shows that a driver recklessly backs into the car, looks at the damage, and then throws a beer bottle at the car and speeds away, the user may call the police, his insurance company, etc., as quickly apprehending the offending party may provide far superior results compared with dealing with the situation at a later time.

User devices 106 may be any type of user devices, including a cellular phone, a smartphone, a personal digital assistant, a laptop computer, a tablet computer, a desktop computer, a smart watch, a head-mounted display, etc. In an example embodiment, a single user may use several different user devices 106, such as a mobile phone and a desktop computer Likewise, the server system 104 may include multiple different physical devices and components, as discussed in further detail below. Further, any number of automobile alert apparatus 102 may be included in the automobile alert system 100. In an example embodiment, the automobile alert system 100 includes many automobile alert apparatuses 102n. Also, a single user device 106 may receive alert information for several different automobile alert apparatuses 102n (e.g., a user receives alerts on a mobile device for each car owned by the user).

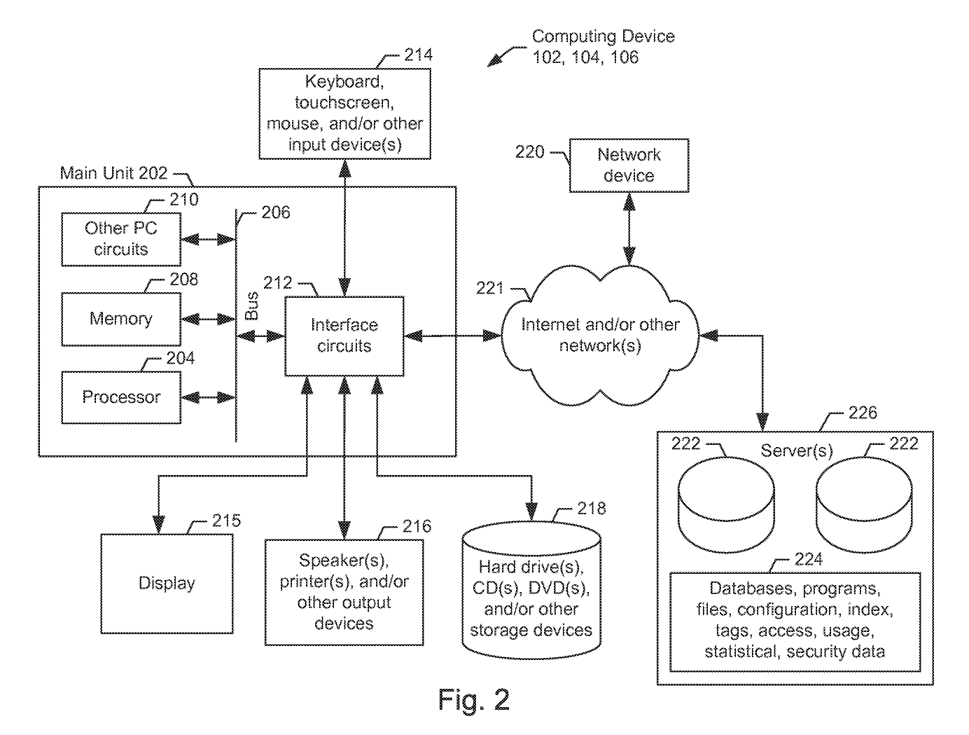

As discussed within the present application, the automobile alert apparatus 102, the server system 104, and the user device 106 may be referred to as computing device(s) 102, 104, 106. A detailed block diagram of the electrical systems of an example computing device 102, 104, 106 is illustrated in FIG. 2. In this example embodiment, the computing device 102, 104, 106 includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors or TEXAS INSTRUMENTS ARM® family of processors. The memory 208 preferably includes volatile memory and non-volatile memory. Preferably, the memory 208 stores a software program that interacts with the other devices in the system 100 as described below. This program may be executed by the processor 204 in any suitable manner. In an example embodiment, memory 208 may be part of a “cloud” such that cloud computing may be utilized by a computing devices 102, 104, 106. The memory 208 may also store digital data indicative of documents, files, programs, web pages, videos, etc. retrieved from a computing device 102, 104, 106 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, image sensor, character recognition, barcode scanner, microphone, and/or a speech or voice recognition system.

One or more displays 215, printers, speakers, and/or other output devices 216 may also be connected to the main unit 202 via the interface circuit 212. The display 215 may be a cathode ray tube (CRTs), a liquid crystal display (LCD), or any other type of display. The display 215 generates visual displays generated during operation of the computing device 102, 104, 106. For example, the display 215 may provide a user interface, which will be described in further detail below, and may display one or more messages, web pages, and/or videos received from a computing device 102, 104, 106. A user interface may include prompts for human input from a user 114 including links, buttons, tabs, checkboxes, thumbnails, text fields, drop down boxes, etc., and may provide various outputs in response to the user inputs, such as text, still images, videos, audio, and animations.

One or more storage devices 218 may also be connected to the main unit 202 via the interface circuit 212. For example, a hard disk drive, CD drive, DVD drive, memory card, flash drive, magnetic disk and/or other storage devices may be connected to the main unit 202. The storage devices 218 may store any type of data, such as alert data, collision data, identifier data, video data, image data, audio data, global position system (GPS) data, map data, threshold data, accelerometer data, velocity data, experimental data, driving history data, insurance data, program data, tag data, historical access or usage data, statistical data, security data, etc., which may be used by the computing device 102, 104, 106.

The computing device 102, 104, 106 may also exchange data with other network devices 220 via a connection to the network 221. Network devices 220 may include one or more servers 226, which may be used to store certain types of data, and particularly large volumes of data (e.g., video data) which may be stored in one or more data repository 222. A server 226 may include any kind of data 224 including databases, programs, files, libraries, pricing data, transaction data, operations data, consumer data, map data, configuration data, index data, tag data, historical access or usage data, statistical data, security data, etc. A server 226 may store and operate various applications relating to receiving, transmitting, processing, and storing the large volumes of data. It should be appreciated that various configurations of one or more servers 226 may be used to support and maintain the system 100. For example, servers 226 may be operated by various different entities. Also, certain data may be stored in a computing device 102, 104, 106 which is also stored on the server 226, either temporarily or permanently, for example in memory 208 or storage device 218. The network connection may include any type of network connection, such as a wireless connection, Ethernet connection, digital subscriber line (DSL), telephone line, coaxial cable, etc.

Access to a computing device 102, 104, 106 can be controlled by appropriate security software or security measures. An individual users' access can be defined by the computing device 102, 104, 106 and limited to certain data and/or actions. Accordingly, users and/or administrators of the system 100 may be required to register with one or more computing devices 102, 104, 106. For example, registered users may be able to request or manipulate data which is not available to others.

As noted previously, various options for managing data located within the computing device 102, 104, 106 and/or in a server 226 may be implemented. A management system may manage security of data and accomplish various tasks such as facilitating a data backup process. A management system may be implemented in a computing device 102, 104, 106 and/or a server 226. The management system may update, store, and back up data locally and/or remotely. A management system may remotely store data using any suitable method of data transmission, such as via the Internet and/or other networks 221.

The computing devices 102, 104, 106 may communicate with other devices via a connection to one or more communications channels 221 such as the Internet or some other data network, including, but not limited to, any suitable wide area network or local area network. It should be appreciated that some of the computing devices 102, 104, 106 described herein may be directly connected to each other instead of over a network 221.

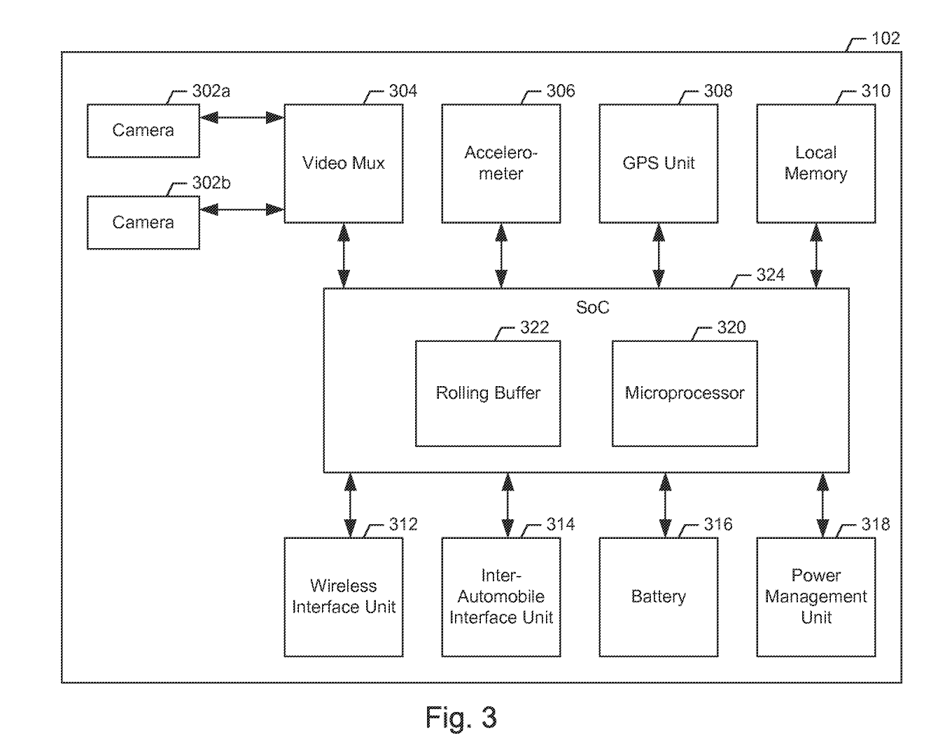

FIG. 3 is a block diagram showing an example of an automobile alert apparatus 102, which includes cameras 302a, 302b, a video multiplexer (mux) 304, an accelerometer 306, a GPS unit 308, a local memory 310, a wireless interface unit 312, an inter-automobile interface unit 314, a battery 316, a power management unit 318, a microprocessor 320, a rolling buffer 322, and a system-on-a-chip (SoC) 324. The cameras 302a, 302b, which may be referred to herein collectively as cameras 302, are provided to record images of the area surrounding the automobile. The cameras 302 may be any suitable type of camera for recording collisions and/or relatively high speed motion, and may be adapted for recording in low light environments. For example, the cameras 302 may be wide angle video cameras. In an example embodiment, the cameras may be configured to record video images at one or more different frame rates (e.g., 7 FPS, 12 FPS, 15 FPS) and/or record still images at the same or higher resolution than the video images. The cameras 302 may connect to a video multiplexer 304 in any suitable manner (e.g., USB, wireless). The video multiplexer 304 may combine the captured video images from the cameras 302 into a stream of data to be processed and stored. The captured images may undergo image processing techniques (e.g., compression) by the microprocessor 320 and be stored as image data in the rolling buffer 322. The rolling buffer may have capacity to store a set amount of video data (e.g., 2,000 frames), which may equate to a certain number of video time (e.g., 45 seconds). The rolling buffer may generally overwrite the oldest frame with each new frame received to maintain the most recent video data (e.g., the last 45 seconds). The rolling buffer may be any suitable form of memory (e.g., RAM, flash) and the image data may be stored as any suitable form of data (e.g., MPEG, JPEG).

The accelerometer 306 may be a tri-axial accelerometer to sense acceleration forces applied to the automobile in any direction. The accelerometer 306 provides accelerometer values or data which may be used by the microprocessor 320 to determine whether to trigger an alert based on accelerometer values of a first period of time. The accelerometer 306 provides accelerometer values or data analog or digital data representative of G force or the like. When the accelerometer values over a period of time indicate an acceleration greater than a predefined threshold has occurred, the microprocessor may determine that a collision has occurred, and an alert is triggered accordingly. For example, determining that a collision occurred may case a flag to be set or an interrupt to be processed. Upon the triggering of an alert, automobile alert information will be transmitted to the user device 106 to notify the user. For example, accelerometer data the video data stored in the rolling buffer 322 may be included with automobile alert information provided to the user. The accelerometer data may be used by the processor 320 to determine a level of impact which indicates a severity of a collision. Thus, a minor ding such as a door of another automobile bumping into the door of the automobile in parking lot, may be a low level impact. A fender bender that results in minor to moderate damage of a bumper or lights may be a medium level impact. A major collision that results in severe damage may be a high level impact. The level of impact may be determined based on a variety of factors, including the weight of the vehicle, placement of accelerometer 306, empirical testing, etc. Also, multiple different predefined thresholds may be used, which trigger different event based on the level of impact.

In an example embodiment, different motion sensing devices, such as one or more rotational sensors, gyroscopic sensors, or the like may be used in conjunction with accelerometer or in lieu of the accelerometer 306 to provide information which is used to determine whether the threshold level of collision occurs, thus triggering an alert. In an example embodiment, several accelerometers 306 may be provided in an alert automobile apparatus 102. In an example embodiment, a first accelerometer may be located in the front bumper, a second accelerometer may be located in the back bumper, and a third accelerometer may be located in a main unit that is mounted in the trunk of the automobile. In an example embodiment, a bus extender (not shown) is used in conjunction with the accelerometer(s) 306 to advantageously enhance the sensitivity achieved with the accelerometer(s) 306. Further, the microprocessor 320 may use different predefined thresholds when the automobile is in different states (e.g., turned off, turned on, driving). In an example embodiment, the microprocessor determines whether the engine or motor of the automobile is turned on or off, and adjusts the predefined threshold to require a higher acceleration value to trigger an alert when the automobile is turned on or driving. Thus, the system advantageously accounts for situations like hitting a pothole, which could trigger an alert if the automobile was parked in a parking lot, but does not warrant triggering an alert while driving. On the other hand, if the car is parked, the predefined threshold may safely be set at a relatively lower level to ensure that any collision, even if minor, is sensed by the system and triggers an alert. The accelerometer data may conform to industry standard protocols or formats to allow for ease of integration and/or use with other systems that use accelerometer data.

The GPS unit 308 may be any suitable GPS unit or other unit for determining a location of the automobile. In an example embodiment, the GPS unit (e.g., ps/2 GPS mouse) is advantageously mounted with an exterior antenna on the exterior of the automobile, to improve accuracy and performance of acquiring the current location of the automobile (e.g., latitude and longitude, street address). The GPS unit 308 provides location data to the microprocessor 320, which may then be provided with the automobile alert information for the user via the wireless interface unit 312. The location of the automobile when a collision occurs can be very important information or evidence, which may be disputed by the operator of an offending automobile. In an example embodiment, the user may use the user device 106 to track the location of the automobile at any time on demand. The GPS data may conform to industry standard protocols or formats to allow for ease of integration and/or use with other systems that use GPS data. The GPS data may be stored in local memory 310, which may be any suitable memory storage device or unit. In an example embodiment, the local memory 310 may be flash memory or hard disk memory. For example, depending on system requirements, the local memory 310 may have a wide range of sizes (e.g., 256 MB, 1 GB, 4 GB, 32 GB). Also, as discussed in further detail below, the local memory 310 may store a wide range of data, including video data, accelerometer data, automobile identification, power management data, etc.

When a collision occurs, the accelerometer 306 will output values indicative of the collision, and the microprocessor 320 uses the accelerometer data to determine when a collision occurs by determining whether an acceleration greater than a predefined threshold is sensed. In an example embodiment, the microprocessor 320 causes several communications to occur. For example, the inter-automobile interface unit 314 may communicate with an inter-automobile interface unit 314 located in the other automobile involved in the collision. Inter-automobile wireless communication may be performed between inter-automobile communication units 314 in different automobiles using a wireless communication protocol such as Bluetooth. In an example embodiment, inter-automobile wireless communication may be provided using any suitable wireless communication protocol (e.g., RFID, NFC, IrDA, Li-Fi). Multiple different wireless communication protocols may be used to insure successful data transmission between automobiles involved in a collision (e.g., Bluetooth and RFID, or RFID and IrDA). In an example embodiment, the inter-automobile interface unit 314 receives a unique automobile identifier from the other automobile which can be used to identify the automobile and the owner or driver of the other automobile. Advantageously, a hit and run driver is unable to succeed in evading responsibility for a collision, as the automobile identification data will be received by the inter-automobile interface unit 314 and stored in the local memory 310.

The wireless interface unit 312 may transmit the automobile alert information to the server system 104. For example, the wireless interface unit 312 may be configured to communicate via multiple protocols employed by cellular networks (e.g., 4G, 3G, GSM), wireless local area network (e.g., Wi-Fi), or satellite (e.g., VSAT). The automobile alert information which is transmitted by the wireless interface unit 312 may include data stored in local memory 310, such as accelerometer data and location data, and may also include the video data stored in the rolling buffer 322. The accelerometer data, location data, and video data may all be time stamped, so the alert information may be further helpful for establishing the facts of what happened in a collision. In an example embodiment, the wireless interface unit 312 may continuously transmit any alert information which is ready to transmit if any network is available, so if alert data is being transmitted via Wi-Fi, which becomes unavailable, a 4G network may be used. In an example embodiment, the wireless interface unit 312 may transmit the automobile alert information directly to a user device 106, for example, when the user device 106 is a mobile device located within the automobile.

The battery 316 may provide power for the automobile alert apparatus 102, and may be any suitable rechargeable type battery (e.g., lithium ion). Power management unit 318 may manage the power distribution for all the components of the automobile alert apparatus 102. The power management unit 318 may provide a predefined voltage to the SoC 324 and any other components using a regulator or the like (e.g, linear regulator, a step down circuit). It should be appreciated that the battery 316 may be embodied as a component of the power management unit 318, and/or the battery 316 and power management unit 318 may interact with each other through the SoC 324 or separate from the SoC 324. The power management unit 318 may user power from an automobile battery (not shown) and recharge the battery 316 with power from the automobile to allow the battery 316 to provide power for extended periods of time when the automobile is turned off.

The microprocessor 320 may be provided in the SoC 324 (e.g., a BeagleBone) to provide a compact, low power, cost effective, and reliable means for processing of video data, accelerometer data, GPS data, automobile identification data, etc., for the automobile alert apparatus 102. The SoC 324 may be implemented in a variety of ways, and some of the components discussed above may be integrated on the SoC 324. For example, the rolling buffer 322 may be implemented as part of the local memory 310, which may be part of the SoC 324. In an example embodiment, the automobile alert apparatus 102 may use other input devices 214. For example, the automobile alert apparatus 102 may record audio data, in addition to video data, using one or more microphones. This additional input data may be processed in a similar fashion as the image data discussed above, and be provided as alert information that the user may access.

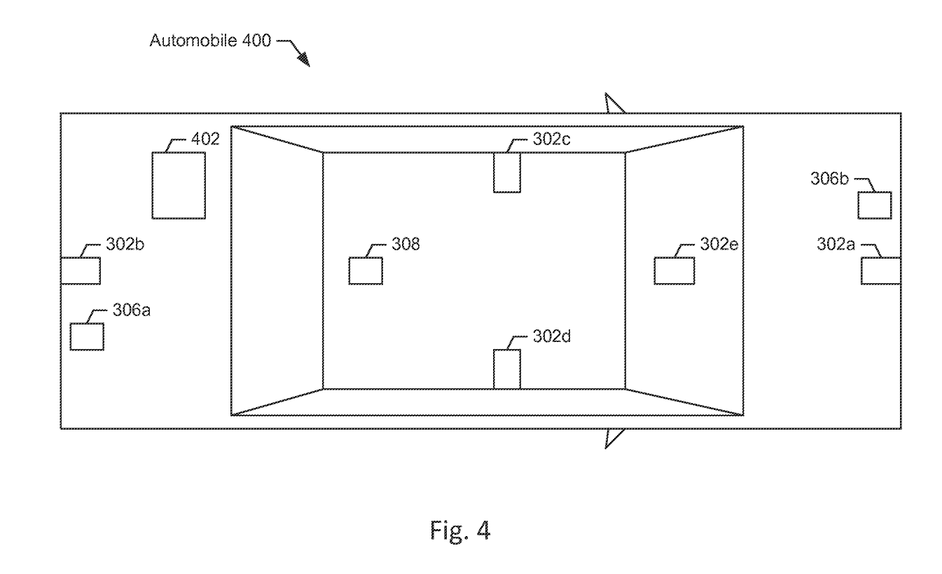

FIG. 4 is a diagram showing an example of an automobile, according to an example embodiment of the present disclosure. As illustrated in FIG. 4, the automobile 400 is shown from an overhead view and includes components of the automobile alert apparatus 102 mounted in various different locations of the automobile 400. A main unit 402 may be installed in a trunk of the automobile or in another interior compartment. The main unit 402 may include a SoC 324, along with a video multiplexer 304, an accelerometer 306, a local memory 310, a wireless interface unit 312, an inter-automobile interface unit 314, a battery 316, and a power management unit 314. The automobile 400 includes five cameras 302a, 302b, 302c, 302d, 302e. The camera 302a is mounted on the front bumper to capture images in the forward direction, the camera 302b is mounted on the rear bumper to capture images in the backward direction, while the cameras 302c and 302d are mounted on the interior of the left and right sides of the automobile 400, to capture images through the windows to the left and right of the automobile 400. Each camera 302 may have a wide angle view (e.g., 170 degree view). Thus, the cameras 302a, 302b, 302c, 302d may capture the full view surrounding the automobile in 360 degrees. Accordingly, any collision should be in the field of view and captured on at least one camera 302. The camera 302e may be provided on the interior of the automobile 400, for example, generally viewing the driver seat and passenger seat, a compartment within the vehicle (e.g., trunk, back seat), or the entire interior of the automobile 400. The cameras 302 may be wired (e.g., USB) to the main unit 402 or communicate wirelessly (e.g., Wi-Fi, 4g) with the main unit 402.

The accelerometer 306a is located in the rear bumper and the accelerometer 306b is located in the front bumper. The accelerometer 306a, 306b may be configured to provide for very fine collision detection which is particularly advantageous for situations where the automobile 400 is turned off. For example, if the automobile 400 is in a parking lot, and a shopping cart bumps into the front bumper, the accelerometer 306b may accurately detect a collision which involved only a very minor impact, but left a long scratch on the paint. The user may be notified on a user device 106 while the user is in the store, which may allow the user to quickly go handle the situation in the parking lot. The predefined threshold may be set for each accelerometer based on the location within the automobile, and also, as discussed above, based on the state of the automobile 400 (e.g., running or off). The GPS unit 308 may be located in a module on top of the automobile 400, to improve location accuracy and acquisition time. It should be appreciated that the components of the automobile alert apparatus 102 may be mounted or placed in various locations within or outside the automobile 400, which may be a car, truck, bus, or the like, as and the illustrated automobile 400 is merely an exemplary embodiment. In an example embodiment, one or more components of automobile alert apparatus 102 may be integral components of an automobile (e.g., GPS unit, accelerometer, microprocessor, memory). Thus, for example, an automobile manufactured by an original equipment manufacturer may include some or all of the components of the automobile alert apparatus 102, which may be implemented using software installed on the automobile, for example, by the original equipment manufacturer. Likewise, a dealership or other after-market entity may install an some or all of the components of the automobile alert apparatus 102 and/or software to operate the automobile alert apparatus 102.

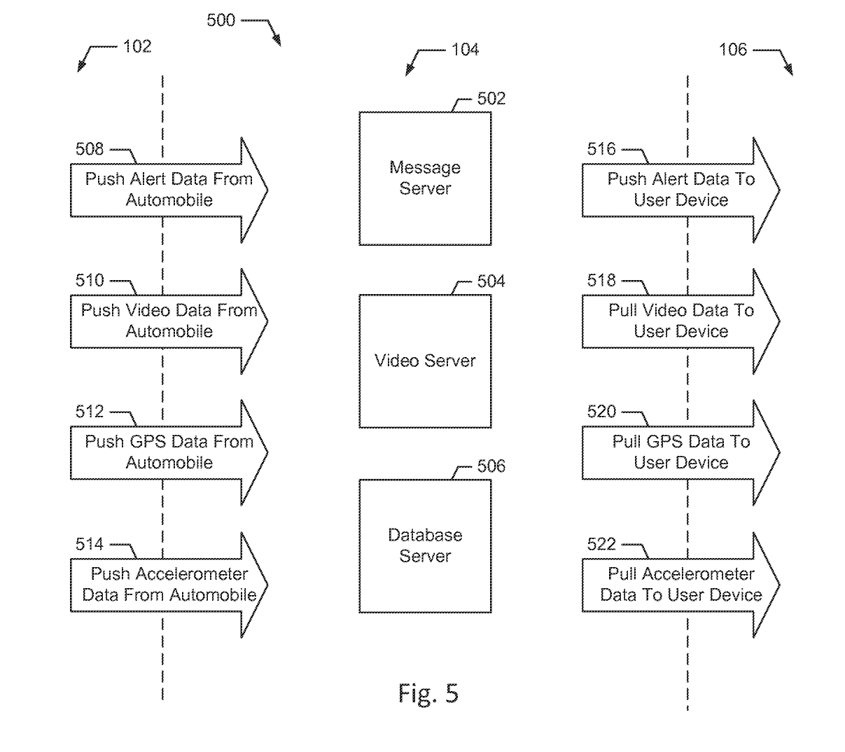

FIG. 5 is a flow diagram illustrating an example process 500 for providing automobile alert information using an example of a server system 104, according to an example embodiment of the present disclosure. Although the process 500 is described with reference to the flow diagram illustrated in FIG. 5, it will be appreciated that many other methods of performing the acts associated with the process 500 may be used. For example, the order of many of the blocks may be changed, certain blocks may be combined with other blocks, some of the blocks described are optional, and blocks may be performed sequentially, concurrently, in serial, in parallel, iteratively, and/or intermittently.

The example server system 104 includes a message server 502, a video server 504, and a database server 506. The servers 502, 504, 506 may be configured on one or more physical devices and/or configured on one or more virtual devices. In an example embodiment, a message server 502 may be configured to parse alert data to form notifications or alerts for users in the form of text messages (e.g., SMS, MMS), email messages, or voice messages. A video server 504 may be an FTP server, which stores a large volume of video data, which can be accessed by users. A database server 506 may be an SQL server which stores current alert data from automobiles and maintains historical alert data for later retrieval by users. In the example process 500, data may generally flow between the automobile alert apparatus 102, the server system 104, and the user device 106, as discussed above in the automobile alert system 100.

In an example embodiment, when a collision occurs, the automobile alert apparatus 102 pushes alert data from the wireless interface unit 312 of the automobile to the server system 104 (block 508). For example, the alert data is immediately (e.g., within 2 seconds) pushed to the server system 104 may include accelerometer data, location data, and automobile identification data of the other automobile, which may be stored in the database server 506. The database server 506 may include a comprehensive list of automobile identification data to provide relevant data associated with any received automobile identification data. For example, the database server 506 may receive a MAC address and provide a license plate number, vehicle identification number, insurance policy number, driver's license number and/or owner name.

The automobile alert apparatus 102 also pushes video data from the wireless interface unit 312 of the automobile to the server system 104 (block 510). For example, if the automobile is turned off, when a collision occurs, the wireless interface unit 312 may immediately start transmitting the video data located in the rolling buffer at the time of the collision. Accordingly, prior to overwriting the video data in the rolling buffer, the video data from before the collision occurred may be pushed to the video server 504. However, the video data may take longer to transfer than the non-video alert data, and further, the video data continues recording for a period of time during the collision and after the collision, so the video data will continue to be pushed until there is no further video data to be pushed to the video server 504. If any interruption in network availability occurs, the wireless interface unit 312 may continuously transmit video data over any network that is available, and if no network is available, the video data will stored and transmitted whenever a network becomes available.

In an example embodiment, the automobile alert apparatus 102 may continuously push GPS data from the wireless interface unit 312 of the automobile to the server system 104 (block 512). For example, every ten seconds, the location may be pushed to the database server 506, which allows for the user to make a request on the user device 106 to see the location of the automobile at any time. Also, the automobile alert apparatus 102 may continuously push accelerometer data from the wireless interface unit 312 of the automobile to the server system 104 (block 514). For example, every ten seconds, the acceleration data may be pushed to the database server 506. Thus, in an example embodiment, the automobile alert system 100 allows for analysis of driving habits data based on accelerometer and GPS data, which can advantageously provide for insurance discounts or the like. In an example embodiment, accelerometer data and/or GPS data may be used to track how fast the automobile is moving, and whether speed limits are being exceeded, which may be useful for an employer monitoring driving habits of employees that drive company vehicles. In an example embodiment, some or all data may only be pushed from the automobile as a result of a collision, while some of the data is always pushed. The user device 106 may be used to modify the data which is pushed to the server system 104 based on a collision and/or with no collision occurring. For example, the user may be provided with options on levels of service regarding which data will be automatically pushed and stored on the server system 104.

In an example embodiment, the server system 104 immediately pushes alert data to the user device (block 516). For example, a message including alert data is immediately (e.g., within 2 seconds, within 15 seconds) pushed from the message server 502 to the user device 106 including a level of impact, the location of the collision, automobile identification data of the other automobile, and a link to download a video of the collision. The user device 106 pulls the video data from the server system 104 (block 518). For example, the user clicks a link to download the video of the collision to the user device 106 from the video server 504. Accordingly, once the user has received the video data, the video evidence of the collision may be redundantly stored in the automobile in the local memory 310, stored in the video server 504, and stored on the user device 106. In an example embodiment, the user may configure the server system 104 to automatically push video data to the user device 106 whenever a collision is detected. The server system 104 may include software for parsing and transmitting appropriate data to the user device 106. Also, the user may be able to configure the level of impact which the system pushes to the user device 106, such as set the system to only send an alert message for a level 2 impact or greater. In an example embodiment, the server system 104 may determine whether to provide identifying information to users and/or other third parties (e.g., police, insurance companies). For example, when receiving a MAC address for with a collision occurring at a first time and first location, prior to transmitting a message with identifying information associated with that MAC address, the server system 104 may check if any corresponding MAC address is received which matches up, thereby confirming the existence of the collision. For example, the server system 104 may determine whether the time of collision, location of collision, and/or levels of impact for received MAC addresses match. If it is determined that the collision information meets a predefined criteria indicating a match, then the server system 104 prepares messages with information specifically identifying both respective drivers, or messages with an enhanced level of identifying information. Thus, the server system 104 may limit any unnecessary private information from being provided to the respective user devices 106 by confirming that the collision was detected in both automobiles prior to transmitting sensitive or private information (e.g., name and driver's license number). In an example embodiment, when the server system 104 determines that a collision has a high level of impact which is likely to result in injuries, a user device 106 used by first responders may receive a message including a location, time, and level of impact, which may result in improved response times for emergency personnel in responding to collisions.

In an example embodiment, the user device 106 pulls GPS data from the server system 104 (block 520). For example, the user requests that the location be provided to the user device 106 on an internet map. In an example embodiment, the user device 106 pulls accelerometer data from the server system 104 (block 522). For example, the user requests that the accelerometer data be provided to the user device 106 in a report on driving habits. In an alternative embodiment, the user may configure the server system 104 to automatically push GPS data and/or accelerometer data to the user device 106 on a periodic basis or a continuous basis.

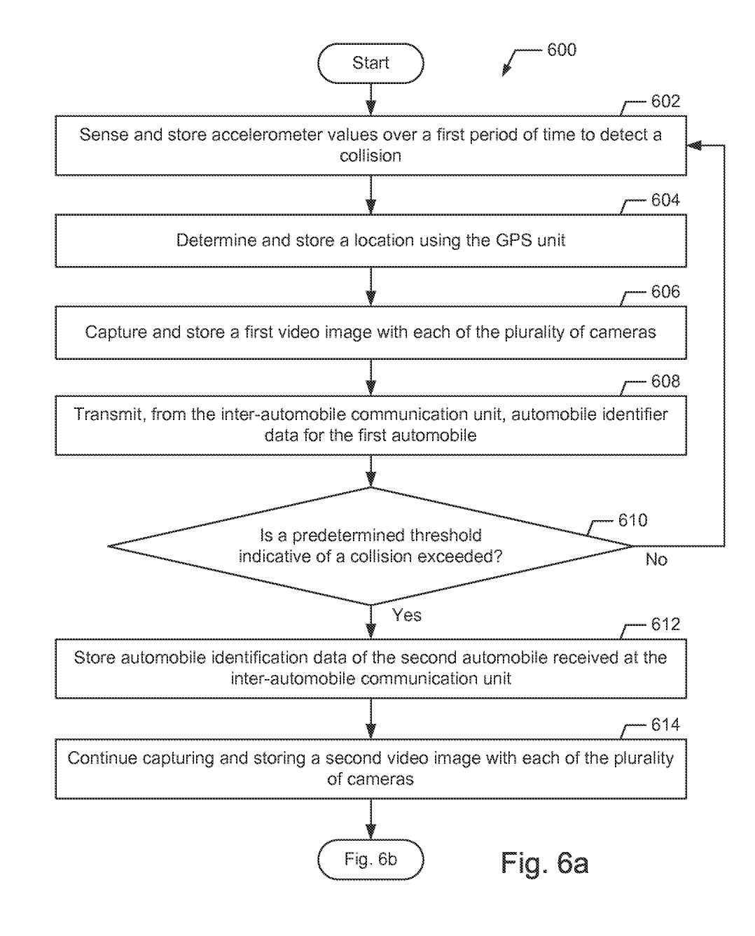

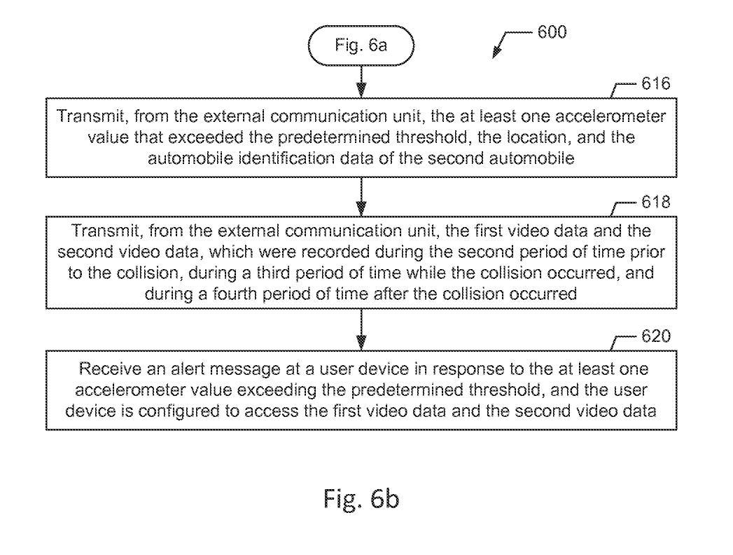

FIGS. 6a and 6b provide a flowchart illustrating an example process for determining a memory distribution across multiple processing nodes, according to an example embodiment of the present disclosure. Although the process 600 is described with reference to the flowchart illustrated in FIGS. 6a and 6b, it will be appreciated that many other methods of performing the acts associated with the process 600 may be used. For example, the order of some of the blocks may be changed, certain blocks may be combined with other blocks, and some of the blocks described are optional.

The example process 600 may begin with sensing and storing accelerometer values over a first period of time to detect a collision (block 602). For example, accelerometer values that are sensed (e.g., every 0.02 seconds) are stored in a log as in time stamped log entries. The example process 600 further includes determining and storing a location with the GPS unit (block 604). For example, the GPS 308 unit may receive a fix approximately every ten seconds, which is stored in time stamped log entries in the local memory 310. The example process 600 further includes capturing a first video image with each of the plurality of cameras and storing first video data for each of the first video images captured by each of the plurality of cameras for a second period of time (block 606). For example, 45 seconds of video data for each of four exterior cameras 302 and one interior camera 302 is recorded in a rolling buffer 322. The example process 600 further includes transmitting, from the inter-automobile communication unit, automobile identification data for the first automobile (block 608). For example, the automobile identification data may be a unique identifier (e.g., MAC address) which is broadcast from the inter-automobile interface unit 314 to uniquely identify the automobile and/or the owner or operator of the automobile to other automobiles. The server system 104 may store a list of each automobile with the unique identifier for that automobile. The server system may implement privacy protocols to only provide information on users to other users when it is appropriate to release such information.

The example process 600 further includes determining whether at least one accelerometer value exceeds a predetermined threshold which is indicative of a collision with a second automobile (block 610). For example, if over a period of 2 seconds, any deviation of the accelerometer values sensed every 0.02 seconds is greater than a predefined threshold, then an alert is triggered. In an example embodiment, a predetermined threshold may be set as an absolute value of a single accelerometer value or a differential of accelerometer values over a period of time. In response to the at least one accelerometer value exceeding the predetermined threshold the alert information is provided to users as discussed in more detail below. Also, in an example embodiment, the user may activate a function on the user device 106 to manually trigger the automobile alert apparatus 102 to push video data from the automobile. For example, when a road rage incident occurs, but there is no collision, the user may still want to push the video data to the server system 104 and/or the user device 106 to permanently record the incident. Accordingly, for example, while continuing to drive the automobile, the user may activate the function by pressing a button or providing a voice command to a user device 106. In another example embodiment, whenever the automobile is turned on or driving, the wireless interface unit 312 may continuously transmit the video data even without a collision occurring.

After the predetermined threshold is exceeded, the example process 600 includes storing automobile identification data of the second automobile received at the inter-automobile communication unit (block 612). For example, the other automobile is broadcasting automobile identification information, which the inter-automobile interface unit 314 receives and stores. If multiple automobiles near a collision are broadcasting automobile identification information, the inter-automobile interface unit 314 may receive information for multiple different automobiles. In an example embodiment, the microprocessor 320 may determine which automobile is in the collision and which automobile is nearby based on a strength of signal for each automobile providing the identification information. Thus, the automobile may exchange automobile identification information with multiple automobiles in the area (e.g., within 10 meters). Accordingly, any witnesses to a collision may advantageously be identified. In an example embodiment, the inter-automobile interface unit 314 may be continuously receiving automobile identification data that is broadcast from other automobiles within range, and may temporarily store the received automobile identification data, and only when the predetermined threshold is exceeded, store the received automobile identification data in local memory 310 for transmission to the server system 104. Thus, the automobile identification information of the offending automobile of an impending collision may be received before the collision actually occurs. In an example embodiment, received automobile identification data may be stored and, when a collision occurs, flagged to be permanently stored and processed further at a later time.

After the predetermined threshold is exceeded, the example process 600 includes continuing to capture and store a second video image with each of the plurality of cameras (block 614). For example, the cameras 300 continue capturing video images during and after the collision for a period of time (e.g., 45 seconds, 2 minutes, 5 minutes, 10 minutes), which are stored in the rolling buffer 322. After the predetermined threshold is exceeded, the example process 600 includes transmitting, from the external communication unit, the at least one accelerometer value that exceeded the predetermined threshold, the location, and the automobile identification data of the second automobile (block 616). For example, log entries including the accelerometer data for the period of time preceding, during, and following the collision, GPS data, and the unique identifier of the other automobile (e.g., MAC address) are immediately transmitted to the server system 104. Further, after the predetermined threshold is exceeded, the example process 600 includes transmitting, from the external communication unit, the first video data and the second video data, which were recorded during the second period of time prior to the collision, during a third period of time while the collision occurred, and during a fourth period of time after the collision occurred (block 618). For example, the rolling buffer 322 may include a 45 seconds of video data for each camera prior to the collision, and an additional 5 minutes of video data from the time of the collision may be transmitted via the wireless interface unit (e.g., Wi-Fi or 4G) to the video server 504. Thus, the video data may show an automobile swerving between lanes prior to impact, clearly establishing fault for the collision. Log entries and video data may be processed in a first-in-first-out (FIFO) queue whenever any network is available. Further, after the predetermined threshold is exceeded, an alert message is received at a user device 106 in response to the at least one accelerometer value exceeding the predetermined threshold, and the user device 106 is configured to access the first video data and the second video data (block 620). For example, the user receives a text message indicating that a level 3 impact has occurred, with the time and location of the collision, and with an indication that an offending automobile's identification information has been acquired with information regarding the offending automobile (e.g., license plate number, vehicle identification number, insurance policy number, driver's license number, owner name), and a link to download the video data showing prior to, during, and after the collision occurred from each camera angle (e.g., front, back, left, right, and interior). In an example embodiment, the server system 104 may control information provided to users and/or other third parties. For example, a message with information identifying another person, or with an enhanced level of identifying information, is only received by a user if both automobiles have detected a collision or detected a specified level of impact.

Thus, the present automobile alert system advantageously provides for redundancy of video data at the automobile alert apparatus 102, the server system 104, and the user device 106, thereby providing a highly effective system for providing evidence of collisions including hit and run incidents, serious collisions resulting in injury or death that require evidence of causation, vandalism, theft, and the like. For example, if a thief breaks into the automobile, the predetermined threshold would be exceeded, triggering the automobile alert apparatus 102 to push the video data prior to the break in, as well as the video data during the actual breaking in, and once the thief has entered the automobile. The thief may find that he is being recorded on camera, and may destroy the automobile alert apparatus 102. However, the thief's efforts would be futile because the video of him breaking and entering the automobile, including close up video of the thief's face obtained by the interior camera 302, would have already been pushed to the server system 104, and an alert message would have been pushed to the user device 106, notifying the user to contact the police or take other appropriate action. Further, the automobile alert apparatus 102 advantageously provides long battery life because when the automobile is turned off, and a collision has not occurred, and video data, alert data, GPS data, and accelerometer data are not being pushed to the server system, the automobile alert apparatus 102 may use very minimal power. Thus, under typical automobile usage circumstances in which the battery 316 is charged when the automobile is turned on, the automobile alert apparatus 102 would never be inoperable due to lack of power, and thus, always monitoring even when left parked in overnight garages or the like for days or weeks. Thus, many advantages are provided to users of by the presently disclosed system, including a reduced risk of payment for damage to an automobile and lower insurance prices.

It will be appreciated that all of the disclosed methods and procedures described herein can be implemented using one or more computer programs or components. These components may be provided as a series of computer instructions on any conventional computer readable medium or machine readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as SoCs, ASICs, FPGAs, DSPs or any other similar devices. The instructions may be configured to be executed by one or more processors, which when executing the series of computer instructions, performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An automobile alert apparatus comprising:
at least one processor;
at least one memory device operably coupled to the at least one processor;
at least one accelerometer;
a global positioning system (GPS) unit;
an inter-automobile communication unit;
an external communication unit; and
a plurality of video cameras,
wherein the at least one processor, the at least one memory device, the at least one accelerometer, the inter-automobile communication unit, the external communication unit, the GPS unit, and the plurality of video cameras are configured within a first automobile, and the at least one processor is configured to execute instructions to operate with the at least one memory device, the at least one accelerometer, the inter-automobile communication unit, the external communication unit, the GPS unit, and the plurality of video cameras, to:
sense accelerometer values over a first period of time to detect a collision;
store the sensed accelerometer values;
determine a location using the GPS unit;
store the location;
capture a first video image with each of the plurality of cameras;
store first video data for each of the first video images captured by each of the plurality of cameras for a second period of time;
transmit, from the inter-automobile communication unit, automobile identification data for the first automobile;
determine whether at least one accelerometer value exceeds a predetermined threshold which is indicative of a collision with a second automobile; and
in response to the at least one accelerometer value exceeding the predetermined threshold:
store automobile identification data of the second automobile received at the inter-automobile communication unit;
continue capturing a second video image with each of the plurality of cameras;
store second video data for each of the second video images captured by each of the plurality of cameras;
transmit, from the external communication unit, the at least one accelerometer value that exceeded the predetermined threshold, the location, and the automobile identification data of the second automobile; and
transmit, from the external communication unit, the first video data and the second video data, which were recorded during the second period of time prior to the collision, during a third period of time while the collision occurred, and during a fourth period of time after the collision occurred,
wherein an alert message is received at a user device in response to the at least one accelerometer value exceeding the predetermined threshold, and the user device is configured to access the first video data and the second video data.

2. The automobile alert apparatus of claim 1, wherein the alert message includes an impact level of the collision based on the at least one accelerometer value that exceeded the predetermined threshold, and the impact level indicates a severity of the collision.

3. The automobile alert apparatus of claim 1, wherein the predetermined threshold is set based on a determination of whether the automobile is in a driving mode.

4. The automobile alert apparatus of claim 3, wherein the driving mode is determined based on whether an at least one of an engine and a motor of the automobile is turned on.

5. The automobile alert apparatus of claim 3, wherein the driving mode is determined based on whether a transmission of the automobile is in one of a plurality of gears including at least a drive gear and reverse gear.

6. The automobile alert apparatus of claim 1, further comprising transferring the first video images from a first memory device in the automobile to a second memory device in the automobile in response to the at least one accelerometer value exceeding the predetermined threshold.

7. The automobile alert apparatus of claim 6, wherein the first memory device is a rolling buffer.

8. The automobile alert apparatus of claim 6, wherein the first video data and the second video data are redundantly stored on the second memory device and on a server remotely located from the automobile.

9. The automobile alert apparatus of claim 1, wherein alert data including at least accelerometer data, GPS data, and video data is pushed to a server system,
wherein alert notifications without video data are pushed to a user device, and
wherein the user device pulls video data to the user device.

10. The automobile alert apparatus of claim 1, wherein the inter-automobile communication unit includes a Bluetooth device.

11. The automobile alert apparatus of claim 1, wherein the external communication unit communicates via at least a 4G network and a Wi-Fi network.

12. The automobile alert apparatus of claim 1, wherein the GPS unit is mounted on the exterior of the automobile.

13. The automobile alert apparatus of claim 1, wherein the at least one accelerometer includes a first accelerometer located in the front bumper, a second accelerometer located in the back bumper, and a third accelerometer located in a main unit mounted in at least one of an interior compartment and a trunk of the automobile.

14. The automobile alert apparatus of claim 1, wherein a graphical user interface of the user device displays at least, a map including a current location of the automobile, a recent alerts list, and a video player configured to play video of each of the recent alerts on the recent alerts list.

15. The automobile alert apparatus of claim 14, wherein the recent alerts list includes a plurality of alerts, each of the alerts identifying a time and a location at which the alert was triggered, an alert level, and identification information of at least one automobile present at the location.

16. The automobile alert apparatus of claim 1, wherein the plurality of cameras collectively provide a 360 degree view around the automobile.

17. The automobile alert apparatus of claim 1, wherein the second period of time is set at one of 15 seconds, 30 seconds, 45 seconds, 1 minute, 2 minutes, 3 minutes, and 5 minutes.

18. The automobile alert apparatus of claim 1, wherein in response to a user manually triggering, while the automobile is in motion, the automobile alert apparatus to push video data from the automobile when the predetermined threshold has not been exceeded by at least one accelerometer value, by activating a function on the user device, the external communication unit transmits at least the first video data.

19. An automobile alert method comprising:
sensing accelerometer values over a first period of time to detect a collision;
storing the sensed accelerometer values;
determining a location with the GPS unit;
storing the location;
capturing a first video image with each of the plurality of cameras;
storing first video data for each of the first video images captured by each of the plurality of cameras for a second period of time;
transmitting, from the inter-automobile communication unit, automobile identification data for the first automobile;
determining whether at least one accelerometer value exceeds a predetermined threshold which is indicative of a collision with a second automobile; and
in response to the at least one accelerometer value exceeding the predetermined threshold:
storing automobile identification data of the second automobile received at the inter-automobile communication unit;
continuing to capture a second video image with each of the plurality of cameras;
storing second video data for each of the second video images captured by each of the plurality of cameras;
transmitting, from the external communication unit, the at least one accelerometer value that exceeded the predetermined threshold, the location, and the automobile identification data of the second automobile; and
transmitting, from the external communication unit, the first video data and the second video data, which were recorded during the second period of time prior to the collision, during a third period of time while the collision occurred, and during a fourth period of time after the collision occurred,
wherein an alert message is received at a user device in response to the at least one accelerometer value exceeding the predetermined threshold, and the user device is configured to access the first video data and the second video data.

20. An automobile alert method comprising:
sensing accelerometer values over a first period of time to detect a collision;
storing the sensed accelerometer values;
determining a location with the GPS unit;
storing the location;
capturing a first video image with each of the plurality of cameras;
storing first video data for each of the first video images captured by each of the plurality of cameras for a second period of time;
determining whether at least one accelerometer value exceeds a predetermined threshold which is indicative of a collision with a second automobile; and
in response to the at least one accelerometer value exceeding the predetermined threshold:
continuing to capture a second video image with each of the plurality of cameras;
storing second video data for each of the second video images captured by each of the plurality of cameras;
transmitting, from the external communication unit, the at least one accelerometer value that exceeded the predetermined threshold and the location; and
transmitting, from the external communication unit, the first video data and the second video data, which were recorded during the second period of time prior to the collision, during a third period of time while the collision occurred, and during a fourth period of time after the collision occurred,
wherein an alert message is received at a user device in response to the at least one accelerometer value exceeding the predetermined threshold, and the user device is configured to access the first video data and the second video data.
